(19) United States
(12) Patent Application Publication
(10) Pub. No.: US 2015/0106468 A1
(43) Pub. Date: Apr. 16, 2015

(54) STORAGE SYSTEM AND DATA ACCESS METHOD

(71) Applicant: NEC Corporation, Minato-ku, Tokyo (JP)

(72) Inventors: Dai Kobayashi, Tokyo (JP); Masaki Kan, Tokyo (JP)

(73) Assignee: NEC Corporation, Minato-ku, Tokyo (JP)

(21) Appl. No.: 14/397,607

(22) PCT Filed: May 16, 2013
(86) PCT No.: PCT/JP2013/063639

§ 371 Date: Oct. 28, 2014

(30) Foreign Application Priority Data
May 17, 2012 (JP) 2012-113183

(51) Int. Cl. H04L 12/24; H04L 29/08; G06F 12/08

(52) U.S. Cl. CPC H04L 41/082; G06F 12/0813; H04L 67/2857; H04L 67/1097; G06F 2212/622
USPC 709/212

(57) ABSTRACT

A distributed storage system which achieves high access performance simultaneously with maintaining the flexibility of allocation of data objects is disclosed. A client terminal includes an asynchronous cache that retains an correspondence relationship between an identifier of object data and an identifier of the storage node that is to handle an access request for the object data, and an access unit that determines the storage node that is to handle the access request on the basis of the correspondence relationship stored in the asynchronous cache, and that transmits the access request to the determined storage node, wherein the storage node includes a determination unit that determines, upon receiving the access request from the client terminal, whether the access request is to be handled by itself, and notifies the client terminal of the determined result, and an update unit that updates the storage node that is to handle the access request, and wherein the asynchronous cache changes the correspondence relationship in accordance with the update, the change being made asynchronous with the update by the storage nodes.

### TECHNICAL FIELD

1. Description of Related Applications

The present invention is based on Japanese Patent Application No. 2012-113183 (filed on May 17, 2012), and the entire content of description of the application is incorporated and described in this description by way of citation.

The present invention relates to storage systems and data access methods and, particularly, a distributed storage system including a plurality of storage nodes and a data access method for a plurality of storage nodes.

2. Background Art

A storage system is a system which stores data therein, and further, provides the stored data. Specifically, a storage system provides basic functions (for access) each for a data piece, such as CREATE (INSERT), READ, WRITE (UPDATE) and DELETE, and further, it provides a variety of functions, such as authority management and data structuring (reduction).

A distributed storage system includes a large number of computers (storage nodes) which are connected to each other via one or more networks, and realizes a storage system by using a hard disk drive (HDD), a memory device or the like included in each of these computers. In such a distributed storage system, software or particular hardware determines on which of the computers each piece of data is to be located, and by which of the computers each piece of data is to be handled. Further, through a method of dynamically changing operation of this distributed storage system, a resource usage amount in the system is adjusted, so that performances provided to a client terminal and its user are improved.

For example, in non-patent literature (NPL) 1, there is disclosed “Google File System” as a distributed storage system in which a meta server manages the locations of data chunks in an integrated manner.

Further, in NPL 2, there is disclosed a technology in which, in a system, a client terminal detects storage nodes storing a target piece of data therein by applying a hash function a plurality of times.

Moreover, in NPL 3, there is disclosed parallel Network File System (pNFS) as a standard technology for a migration (movement) of data.

Further, in NPL 4, although not a technology for the distributed storage system, there is disclosed a Web server as a data storage system provided with a plurality of computers, each of which includes a cache for name resolutions in a domain name system (DNS), and a cache for DNS entries. A piece of location information related to this Web server is denoted by a uniform resource locator (URL) including a pair of a server name and an object name. The server name of these is converted into an actual server address by a service provided by a DNS server. There is also a case where part of aggregate of information stored in this DNS server is cached into a client terminal for the purpose of a performance improvement.

Moreover, in NPL 5, there is disclosed a technology using Apache, which is a piece of software for a Web server. In the technology, a server's own name (domain name) is set in advance, and when access having a server's name different from the server's own name has been erroneously received, this access is rejected.

### CITATION LIST

### Patent Literature

PTL 1: International Publication WO 2012/023384

### Non Patent Literature

NPL 1: Sanjay Ghemawat, Howard Gobioff, and Shun-Tak Leung, “The Google File System,” SIGOPS Oper. Syst. Rev. 37, 5 (October 2003), pp. 29-43

NPL 2: Ion Stoica, Robert Morris, David Karger, M. Frans Kaashoek, Hari Balakrishnan, “Chord: A Scalable Peer-to-peer Lookup Service for Internet Applications,” ACM SIGCOMM Computer Communication, Review 31(4), pp. 149-160, ACM Press, 2001

NPL 3: S. Shepler, et al., “Network File System (NFS) Version 4 Minor Version 1 Protocol,” RFC 1035, Internet Engineering Task Force (IETF), 2010

NPL 4: P. Mockapetris, “Domain Names—Implementation and Specification,” RFC 1035, Network Working Group, 1987

NPL 5: Apache Software Foundation, “Apache HTTP Server Version 2.2 Apache Core Function”, [online], [search on Apr. 27, 2012], the Internet <URL: http://httpd.apache.org/docs/2.1/ja/mod/core.html>

### TECHNICAL PROBLEM

The entire content of disclosure of each of the above PTL 1 and NPL 1 to 5 is incorporated and described in this description by way of citation. The following analyses have been made by the inventors of the present invention.

In a distributed storage system, data is distributed to each of a plurality of storage nodes and is stored therein. Accordingly, when a client terminal accesses for data, the client terminal needs to grasp a storage node retaining the data. Further, if there exists a plurality of storage nodes retaining access target data, the client terminal needs to grasp to which ones of the storage nodes access is to be made.

Stored data is accessed for in a semantic unit. For example, in a relational database, sometimes, data is written in a unit which is called “record” or “tuple”. In a file system, data is written as an aggregate of blocks. In a key-value store, data is written as an object. Data having been written in such a way is read in by a client terminal for each unit of the data. Hereinafter, this unit of data will be called “a data object”.

As a method by which a client terminal grasps a storage node retaining a target data object, there is known a method of providing the meta server including one or more computers for managing pieces of location information each indicating a corresponding one of data objects (this method of providing such a meta server being referred to as “a meta server method” hereinafter).

According to the meta server method disclosed in NPL 1, while a size of a storage system becomes larger, processing performance of the meta server for use in retrieving the location of a storage node storing a target data object therein becomes more insufficient. Therefore, the meta server becomes a bottleneck in access performance. Further, according to the meta server method, the client terminal needs to access the meta server before accessing a storage node storing a target data object therein, and thus, it takes longer time to make data access. In particular, when the client terminal and the meta server are located far from each other and it takes time for network access, data access time remarkably increases.

In order to solve this problem, there exists a well-known technology in which part of data location information existing on the meta server is cached into each client terminal which makes access or into a different computer. If a client terminal is capable of using cached location information, the client terminal becomes capable of directly accessing a storage node storing a target data object therein without accessing the meta server. Here, there exist synchronous caching and asynchronous caching as caching methods.

In the synchronous caching, every change made to location information (original information) existing on the meta server is synchronously applied to each of caches, and thus, a client terminal is capable of selecting the relevant storage node in accordance with the latest pieces of correct information. Nevertheless, according to the synchronous caching, it is necessary to reflect an update having been made on the original information into all the caches, and thus, it takes long time to complete the update of the original information. Further, according to the synchronous caching, it is necessary for each of the caches to confirm whether or not any update has been made on the original information, and thus, the performance of the storage system is likely to degrade.

Meanwhile, in the asynchronous caching, any change made to the location information (original information) existing on the meta server is not synchronously applied to each of the caches, and thus, there occurs a situation where, in accordance with non-updated location information, a client terminal erroneously accesses a storage node which does not retain a target data object. Meanwhile, according to the asynchronous caching, even when highly frequent updates on the original information have been made, updates on each of the caches can be collectively applied with a time lag.

As another method by which a client terminal grasps a storage node retaining a target data object, there exists a method of obtaining a storage node storing a target data object therein by using a dispersion function, such as a hash function (this method being referred to as “a dispersion function method” hereinafter). In this dispersion function method, all client terminals share a list of storage nodes participating in a system, and a dispersion function. Further, stored data is divided into data pieces (values) each having a fixed length or an optional length, and each of the values is given an identifier (key) for uniquely identifying the each value itself.

When accessing for data, a client terminal gives a key to the dispersion function as an input, and arithmetically obtains a storage node storing the data therein on the basis of an output value of the dispersion function as well as the list of storage nodes. For example, according to a technology disclosed in NPL 2, a client terminal detects storage nodes each existing in a system and storing target data therein by applying a hash function a plurality of times.

According to such a dispersion function method, each client terminal is capable of accessing any of storage nodes without through the meta server which is intensively accessed. Accordingly, there is no possibility that the meta server becomes a bottleneck in performance. PTL 1 discloses a technology in which allocation of data is determined by using a random number generating function.

Meanwhile, in the distributed storage system, there is known a technology of moving (migrating) a data object stored in a certain storage node to another storage node. Such move of data objects are performed for the purpose of, for example, preventing the occurrence of a situation in which a particular storage node is intensively accessed. The performances of the entire system, such as throughput, latency and power consumption, are improved by equally dispersing a usage amount of resources of the computers which provide a data access service.

Further, there is a case where, when a certain data object and another data object coexist in the same storage node, access for each of the data objects can be performed at a higher speed as compared with a case where these data objects exist in their respective separate storage nodes. For example, if it is necessary to maintain consistency and a matching property between a data object A and a data object B, there arises communication between each of storage nodes which stores therein a corresponding one of the data object A and the data object B and a software process which manages the consistency between these data objects. When such access arrives frequently, if the storage nodes and the software process are operating on the same computer, the communication between computers becomes unnecessary, and thus access for each of the data objects can be made at a higher speed. Accordingly, moving data objects such that the data object A and the data object B are stored in a single storage node. In such a case also moving data objects are performed among a plurality of storage nodes.

Moreover, moving data objects are dynamically performed even during an operation of a system. This is because a tendency in which stored data objects are utilized is likely to vary with an elapse of time.

For example, if a data object is a document at a business site, the following life cycle can be conceived. As an example, there is a case where a data object is frequently edited immediately after creating the data object, and when the creation have completed and the created data object is circulated among users, it causes a generation of a large number of reference requests, and afterwards, the data object is only fairly infrequently accessed and is kept storing so as not to be lost. Further, the data object is deleted when the content of the storage is rearranged after several years. As another example, there is a case where a data object used at an office in a certain country is frequently accessed during work hours in the country (for example, at daytime), and is only infrequently accessed during hours other than the work hours (for example, at midnight). Meanwhile, a data object used at an office in a different country is frequently accessed during work hours in the different country, and is only infrequently accessed during hours other than the work hours.

As described above, the frequency of access for a data object is likely to vary in unit of several hours or several months, and thus, it is necessary to dynamically change the allocation of data objects even during an operation of the distributed storage system.

According to the meta server method, it is easier to change storage nodes on which data objects are allocated, as compared with the dispersion function method. In the meta server method, an identifier or an address of each of one or more storage nodes on which each data object is allocated is stored in the meta server.

For example, it is known a method in which an entry is created for each data object, and identifiers or addresses, each associated with a corresponding one of one or more storage nodes in which the each data object is stored, are written in the entry for the each data object. According to this method, when a data object (this will be called “a data object A”) existing on a first storage node N1 has been moved to a second storage node N2, it is enough just to change a designation which is written in an entry for the data object A and which designates the first storage node N1 to a designation which designates the second storage node N2. As a result, any access for the data object A from a client terminal after the change regarding the entry reaches the second storage node N2.

According to the meta server method, generally, for each of data objects, any one of storage nodes can be made a migration (move) destination thereof. In this regard, however, if, in order to improve fault tolerance, one or more copies of a data object are each stored in a corresponding one of other storage nodes, there also occurs a case where, in order to maintain the redundancy of the data object, a restriction is imposed on a selection of a storage node as a migration destination of the data object.

Meanwhile, according to the dispersion function method, allocation of each data object is determined in accordance with outputs of a dispersion function. Accordingly, in the dispersion function method, it is impossible to, for each data object, set a migration destination in an optional manner.

For example, it is supposed that, as a result of applying a dispersion function h to a data object A, a relation “h(A)=n1” is obtained, and the data object A is stored in the first storage node N1 corresponding to the hash value n1. In this case, in order to move the data object A to the second storage node N2 corresponding to a hash value n2, it is necessary to change the dispersion function from “h” to “h′” to obtain a relation “h′(A)=n2”. Nevertheless, the dispersion function h′( ) needs to satisfy a relation “h′(X)=h(X)=n1” for a data object X that is any one of data objects which are stored in the storage node N1 and which are other than the data object A. Nevertheless, in order to find out the dispersion function “h′” having such a property, an enormous amount of calculation is needed. Thus, according to the dispersion function method, it becomes difficult to migrate a data object to any one of storage nodes.

In the pNFS disclosed in NPL 3, when target data is already migrated, either an error response indicating that target data is already migrated or a new move destination is sent back to a client terminal. Nevertheless, basically, the pNFS is a technology for data allocation control based on the meta server method, and particularly, while dealing with data CREAT, a metadata server (MDS) is likely to become a bottleneck in performance.

Hereinafter, when, for any one of data objects, the number of storage nodes which can be set as migration destinations thereof is large, this situation will be phrased such that “allocation of data objects is flexible”. In particular, when any one of data objects can be migrated to any one of storage nodes, this situation will be phrased such that “allocation of data objects is most flexible”.

In order to realize a distributed storage system, which is flexible in allocation of data objects, on the basis of the aforementioned related technologies, the use of the meta server method is conceived. According to the meta server method, allocation of data objects becomes most flexible when any copy of a data object is not taken into consideration. Nevertheless, according to the meta server method, as described above, the meta server becomes a bottleneck, so that access performance is likely to degrade.

Besides the meta server method, a method of providing an asynchronous cache in each client terminal is conceived as another method for achieving a distributed storage system, which is flexible in allocation of data objects, on the basis of the aforementioned related technologies. According to this method, with respect to access, such as READ or WRITE (UPDATE), for a data object already existing on a storage system, a client terminal can determine a storage node to be accessed, by using entries which are part of entries on the meta server and which have been cached from the meta server. Nevertheless, with respect to access, such as CREATE, which entails increasing or decreasing of the entries existing on the meta server, there is a case where a client terminal fails to determine any location of the storage node on the basis of the cache, so that access to the meta server is likely to arise frequently. Thus, although this method is suitable for a moving-image server or the like which provides or updates existing contents, this method is not suitable for a storage system in which a new data object is added in series, just like a storage system which stores therein log data, consumer generated media (CGM) or the like.

Meanwhile, according to the dispersion function method, with respect to each of access types including CREATE, a client terminal can determine the storage node without depending on the meta server. Nevertheless, as described above, in the dispersion function method, there is a problem that flexibility in allocation of data objects is insufficient.

In addition, both of the technology disclosed in NPL 4 and the technology disclosed in NPL 5 do not premise any migration of data, and thus, they cannot solve the aforementioned problems.

In a distributed storage system, therefore, it becomes an issue to be solved to achieve high access performance simultaneously with ensuring the flexibility of allocation of data objects. An object of the present invention is to provide a storage system and a data access method which make it possible to solve this issue.

### SUMMARY OF THE INVENTION

A storage system according to a first aspect of the present invention includes:
a client terminal; and
a plurality of storage nodes,

wherein the client terminal includes an asynchronous cache that retains an correspondence relationship between an identifier of object data and an identifier of the storage node that is to handle an access request for the object data, and an access unit that determines the storage node that is to handle the access request on the basis of the correspondence relationship stored in the asynchronous cache, and that transmits the access request to the determined storage node,

wherein the storage node includes a determination unit that determines, upon receiving the access request from the client terminal, whether the access request is to be handled by itself, and notifies the client terminal of the determined result, and an update unit that updates the storage node that is to handle the access request, and

wherein the asynchronous cache changes the correspondence relationship in accordance with the update, the change being made asynchronous with the update by the storage nodes.

A data access method according to a second aspect of the present invention includes:
retaining, by a client terminal, an correspondence relationship between an identifier of object data and an identifier of the storage node that is to handle an access request for the object data into an asynchronous cache;

determining, by the client terminal, the storage node that is to handle the access request on the basis of the correspondence relationship stored in the asynchronous cache, and transmitting, by the client terminal, the access request to the determined storage node;

determining, by the storage node which receives the access request from the client terminal, whether or not the access request is to be handled by itself, and notifying, by the storage node, the client terminal of the determined result;

updating, by the storage node, the storage node that is to handle the access request; and

changing, by the client terminal, the correspondence relationship stored in the asynchronous cache in accordance with the update, the change being made asynchronous with the update by the storage node.

### Advantageous Effects of Invention

In the storage system and the data access method according to some aspects of the present invention, it is possible to achieve high access performance simultaneously with maintaining the flexibility of allocation of data objects.

### BRIEF DESCRIPTION OF DRAWINGS

FIG. 1 is a block diagram illustrating an example of a configuration of a storage system according to the first exemplary embodiment.

FIG. 2 is block diagram illustrating an example of a configuration of a storage system according to the first exemplary embodiment.

FIG. 3 is a block diagram illustrating an example of a configuration of a storage system according to the first exemplary embodiment.

FIG. 4 is a diagram for describing a CREATE sequence in a storage system according to the first exemplary embodiment.

FIG. 5 is a diagram for describing a case where a false storage node is accessed during a CREATE sequence in a storage system according to the first exemplary embodiment.

FIG. 6 is a diagram for describing a sequence for READ or UPDATE in a storage system according to the first exemplary embodiment.

FIG. 7 is a diagram for describing a case where a false storage node is accessed during a sequence for READ or UPDATE in a storage system according to the first exemplary embodiment.

FIG. 8 is a block diagram illustrating an example of a configuration of a storage system according to a second exemplary embodiment.

FIG. 9 is a diagram for describing a sequence for READ or UPDATE in a storage system according to the second exemplary embodiment.

### DESCRIPTION OF EMBODIMENTS

First, an outline of an exemplary embodiment will be described. In addition, drawing reference signs appended in this outline are just exemplification for entirely assisting understanding of the outline, and they are not intended to limit the present invention to a configuration illustrated in a drawing referred to below.

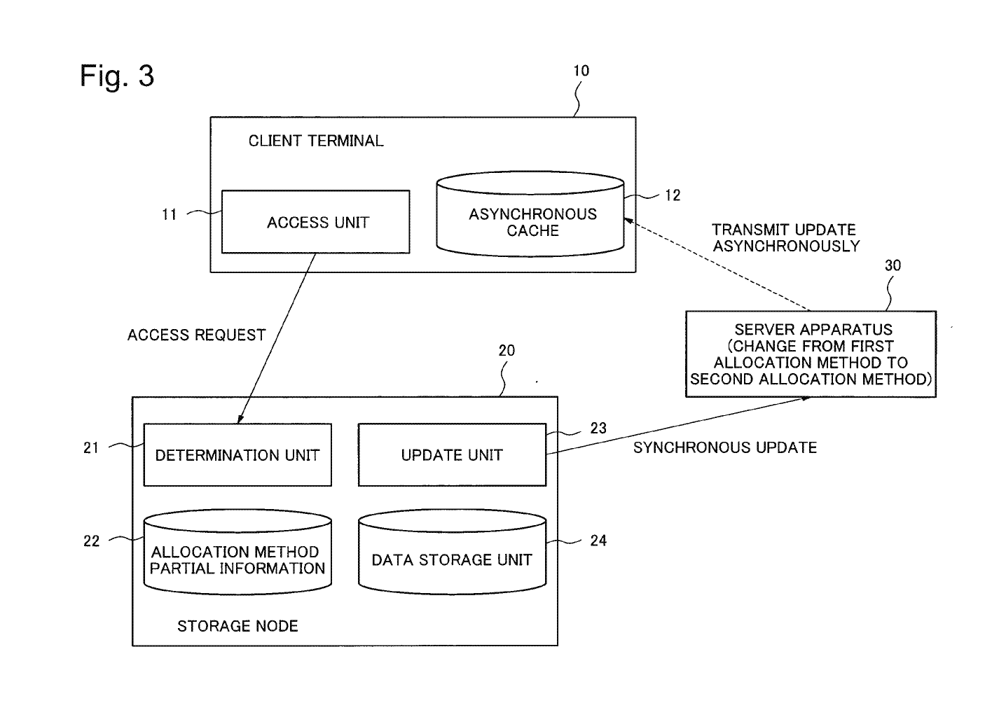

FIG. 3 is a block diagram illustrating an example of a configuration of a storage system according to the exemplary embodiment. Referring to FIG. 3, this storage system includes a client terminal (10) and a plurality of storage nodes (20). In addition, in FIG. 3, only a single storage node is illustrated for the sake of simplification.

The client terminal includes an asynchronous cache (12) and an access unit (11). The asynchronous cache (12) retains correspondence relationships between identifiers of pieces of object data and identifiers of storage nodes that are to handle an access request for one of the pieces of object data. The access unit (11) determines the storage node that is to handle the access request on the basis of the correspondence relationships stored in the asynchronous cache (12), and transmits the access request to the determined storage node.

The storage node (20) includes a determination unit (21) and an update unit (23). Upon receiving the access request from the client terminal (10), the determination unit (21) determines whether or not the access request is to be handled by itself, and notifies the client terminal (10) of the determined result. The update unit (23) updates the storage nodes that are to handle the access requests.

The asynchronous cache (12) changes the aforementioned correspondence relationships asynchronous with the above update by each of the plurality of storage nodes, in accordance with the above update thereby.

Referring to FIG. 3, the storage system may include a server apparatus (30). The server apparatus (30) accumulates a piece of update information representing the content of the above updating performed by each of the plurality of storage nodes. In this case, when having updated the storage node that is to handle an access request, the update unit (23) of each of the plurality of storage nodes notifies the server apparatus (30) of the information indicating the content of the update. Further, the asynchronous cache (12) changes the aforementioned correspondence relationships asynchronous with the above update by each of the plurality of storage nodes, in accordance with the pieces of update information having been accumulated in the server apparatus (30).

According to such a storage system, as compared with a storage system based on the dispersion function method, a larger number of storage nodes can be made migration destinations of pieces of object data, and thus flexible data allocation can be achieved. Further, a client terminal becomes capable of, without utilizing the meta server, accessing a storage node on the basis of an aggregate of information contained in an asynchronous cache provided in itself, and thus, it becomes possible to prevent the occurrence of a situation in which the meta server becomes a bottleneck because of data access requests made by a large number of client terminals, and this brings about high access performance. Accordingly, according to the storage system according to an exemplary embodiment described above, high access performance can be achieved simultaneously with ensuring the flexibility of allocation of data objects.

Further, the asynchronous cache (12) may retain only correspondence relationships between identifiers of pieces of object data each having been moved between the storage nodes and identifiers of storage nodes each are to handle the access request for the object data. Moreover, processing may be performed such that, when having failed to determine a storage node that is to handle a certain access request on the basis of the correspondence relationships stored in the asynchronous cache (12), the access unit (11) determines a storage node that is to handle the access request on the basis of a given dispersion function, and transmits the access request to the determined storage node.

In this case, it becomes possible to obtain a data allocation method resulting from combining an allocation method which has a difficulty in a data migration (for example, the dispersion function method) and an allocation method which is flexible in data allocation (for example, the meta server method). In the allocation method, such as the meta server method, which is flexible in data allocation, “CREATE” becomes a bottleneck. Thus, destinations regarding “CREATE” are determined in advance by using the dispersion function method, only migrated data objects are managed by using the meta server method, and an asynchronous cache is provided in each client terminal. In this way, a large number of CREATE access requests directly reach their respective destination storage nodes, and access requests for partial data objects having been migrated are each allocated to an appropriate storage node by the determination unit (21). In this case, it becomes possible to provide a distributed storage system which makes it possible to achieve flexible data allocation simultaneously with maintaining a matching property in data allocation, and achieve high-speed processing by preventing the meta server from becoming a bottleneck.

In addition, in the present invention, the following configurations can be made.

### [Configuration 1]

This is just like the storage system according to the first aspect.

### [Configuration 2]

The storage system may further include a server apparatus that accumulates a piece of update information representing content of the update by the storage node; when the update unit of the storage node updates the storage node that is to handle the access request, the update unit may notify the server apparatus of the update information representing content of the update; and the asynchronous cache may change the correspondence relationship in accordance with the update information accumulated in the server apparatus, the change being made asynchronous with the update by the storage nodes.

### [Configuration 3]

The server apparatus may periodically notify the update information to the client terminal, and the asynchronous cache may change the correspondence relationship in accordance with the update information which is notified by the server apparatus.

### [Configuration 4]

The server apparatus may notify the update information to the client terminal when a data amount of the update information becomes larger than or equal to a predetermined size, and the asynchronous cache may change the correspondence relationship in accordance with the update information which is notified by the server apparatus.

### [Configuration 5]

The access unit may request the sever apparatus to notify the update information to the client terminal when the determination unit determines the storage node is not to handle the access request, the storage node being determined on the basis of the correspondence relationship by the access unit, and the asynchronous cache may change the correspondence relationship in accordance with the update information which is notified by the server apparatus in response to the request.

### [Configuration 6]

The determination unit may transfer the access request to one of the storage nodes that is to handle the access request when the access request is not to be handled by the storage node itself which includes the determination unit.

### [Configuration 7]

The asynchronous cache may retain only the correspondence relationship between an identifier of the object data which already being moved between the storage nodes and an identifier of the storage node that is to handle the access request for the object data, and when the access unit fails to determine any one of the storage nodes that is to handle the access request on the basis of the correspondence relationship retained by the asynchronous cache, the access unit may determine one of the storage nodes that is to handle the access request on the basis of a predetermined dispersion function, and may transmit the access request to the determined storage node.

### [Configuration 8]

This is just like the aforementioned data access method according to the second aspect.

### [Configuration 9]

The data access method may further include accumulating, by a server apparatus, a piece of update information representing content of the update by the storage node; when updating, by the storage node, the storage node that is to handle the access request, notifying, by the storage node, the server apparatus of the update information representing content of the update; and changing, by the client terminal, the correspondence relationship stored in the asynchronous cache in accordance with the update information accumulated in the server apparatus, the change being made asynchronous with the update by the storage nodes.

### [Configuration 10]

The data access method may further include notifying, by the server apparatus, the update information to the client terminal periodically; and changing, by the client terminal, the correspondence relationship stored in the asynchronous cache in accordance with the update information which is notified by the server apparatus.

### [Configuration 11]

The data access method may further include notifying, by the server apparatus, the update information to the client terminal when a data amount of the update information becomes larger than or equal to a predetermined size; and changing, by the client terminal, the correspondence relationship stored in the asynchronous cache in accordance with the update information which is notified by the server apparatus.

### [Configuration 12]

The data access method may further include requesting, by the client terminal, the sever apparatus to notify the update information to the client terminal when the storage node, which received the access request, determines the storage node is not to handle the access request, the storage node being determined on the basis of the correspondence relationship by the client terminal; and changing, by the client terminal, the correspondence relationship stored in the asynchronous cache in accordance with the update information which is notified by the server apparatus in response to the request.

### [Configuration 13]

The data access method may further include, when the access request is not to be handled by the storage node itself which received the access request, transferring, by the storage node, the access request to the storage node that is to handle the access request.

### [Configuration 14]

In the data access method, the asynchronous cache may retain only the correspondence relationship between an identifier of the object data which already being moved between storage nodes and an identifier of the storage node that is to handle the access request for the object data, and when any one of the storage nodes that is to handle the access request fails to be determined by the client terminal on the basis of the correspondence relationship stored in the asynchronous cache, one of the storage nodes that is to handle the access request may be determined by the client terminal on the basis of a predetermined dispersion function, and the access request may be transmitted to the determined storage node by the client terminal.

### Exemplary Embodiment 1

A distributed storage system according to a first exemplary embodiment will be described with reference to some of the drawings.

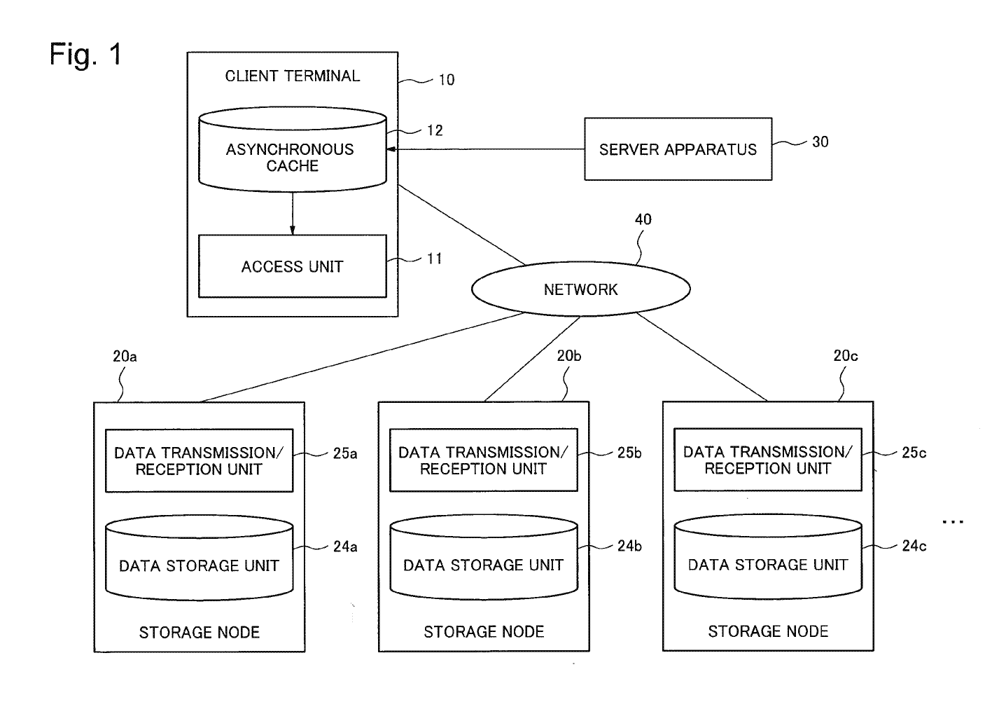

FIG. 1 is a block diagram illustrating a configuration of a storage and access of data in a distributed storage system of this exemplary embodiment. Referring to FIG. 1, this distributed storage system includes a client terminal 10 connected to a network 40, storage nodes 20a to 20c each connected to the network 40, and a server apparatus 30. In FIG. 1, although the number of the storage nodes is made three as an example, the number of the storage nodes is not limited to this.

The storage nodes 20a to 20c include data transmission/reception units 25a to 25c and data storage units 24a to 24c, respectively. The client terminal 10 includes an access unit 11 and an asynchronous cache 12.

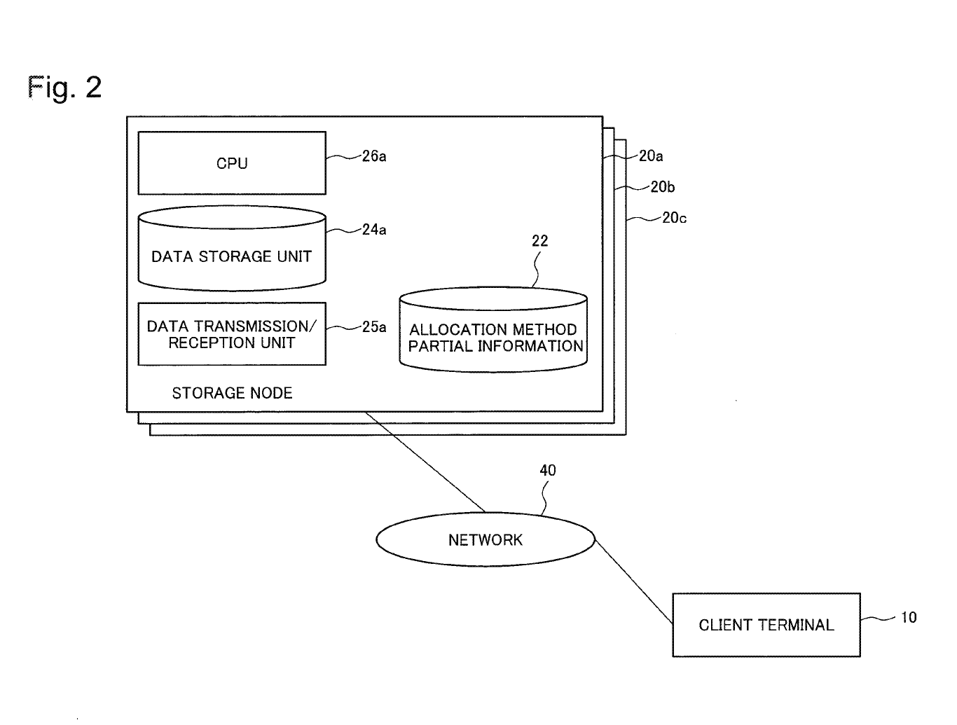

FIG. 2 is a block diagram illustrating, in detail, a configuration of each of the storage nodes 20a to 20c of FIG. 1. Referring to FIG. 2, the client terminal 10 is connected to each of the storage nodes 20a to 20c via the network 40.

The storage node 20x (x is any one of a to c) includes a central processing unit (CPU) 26x, the data storage unit 24x, the data transmission/reception unit 25x and an aggregate of allocation method partial information 22x. The CPU 26x realizes a function implemented in each portion of the distributed storage system of this exemplary embodiment, in cooperation with software.

The data storage unit 24x (x is any one of a to c) is, for example, a HDD; a flash memory; a dynamic random access memory (DRAM); a spin torque transfer RAM (STT-RAM); a magnetoresistive random access memory (MRAM); a ferroelectric random access memory (FeRAM); a phase change RAM (PRAM); a storage device united with a redundant array of inexpensive disks (RAID) controller, a solid state drive (SSD) controller or the like; a physical medium capable of recording data therein, such as a magnetic tape; or a control device for recording data into a medium installed outside the storage node.

The network 40 and the data transmission/reception unit 25x (x is any one of a to c) can be realized by implementing, for example, Ethernet (registered trademark), Fibre Channel, Fibre Channel over Ethernet (registered trademark) (FCoE), InfiniBand, QsNet, Myrinet, PCIExpress, Thunderbolt, or an upper layer protocol utilizing one of these above, such as transmission control protocol/Internet protocol (TCP/IP) or remote direct memory access (RDMA). In addition, a method for realizing the network 40 and the data transmission/reception unit 25x (x is any one of a to c) is not limited to these.

Storage data is stored in the data storage units 24a to 24c included in their respective associated storage nodes 20a to 20c as an aggregate of data pieces (data objects) resulting from segmentation in a fixed-length unit or in a semantic unit. Each data object is given a unique identifier (key). The client terminal acquires a desired data object by designating a key corresponding thereto. Further, configuration may be made such that a copy of each data object is stored in each of a plurality of storage nodes. Further, configuration may be made such that, as a substitution for each data object, or together with each data object, redundant code information resulting from a calculation based on the each data object is stored in another storage node. Here, such redundant code information is used for the purpose of, when partial data objects become in the state of being difficult to be accessed for because of a malfunction of one of the storage nodes, preventing the loss of the partial data objects.

As an example of the data object, there can be conceived, for example, a block or a sector of a block storage; a file of a file system; an aggregate of metadata related to a file; a tuple or a table of a relational database; data of an object database; Value of a Key-Value data storage system; content enclosed by tags in an extensible markup language (XML) document; a resource of a resource description framework (RDF) document; a data entity of Google App Engine; a message of Microsoft Windows (registered trademark) Azure queue; Column of Wide Column Store, such as Cassandra; or a document written in JavaScript (registered trademark) object notation (JSON) or in binary JSON (BSON).

Further, as an example of a key corresponding to a data object, there can be conceived, for example, a block number; a pair of a logical volume identifier and a block number; a sector number; a file name; a metadata property name; a pair of the file name and the metadata property name; a primary key value of a tuple; a table name; a pair of the table name and the primary key value; an object name; an object identifier (ID); a tag name; and a resource name. In addition, the data object and the key in this exemplary embodiment are not limited to these.

The access unit 11 of the client terminal 10 identifies the storage node retaining a target data object from a data key and identifiers each for identifying a corresponding one of the storage nodes, and transmits or receives the target data object to/from the identified storage node. Specifically, the identification of the storage node retaining a target data object is performed via the asynchronous cache 12 provided in the client terminal 10. The asynchronous cache 12 retrieves via the server apparatus 30 and stores therein part of or the whole of partial information which is related to the allocation method and which is possessed by each of the storage nodes (that is, the partial information representing the storage node that is to handle the access request, and being referred to as “an aggregate of allocation method partial information” hereinafter).

Here, the allocation method means a data structure or an algorithm which makes it possible to determine one or more storage nodes each becoming a storage destination on the basis of the content of the asynchronous cache 12. Further, with respect to a data object to be newly created, the allocation method makes it possible to determine the storage node which newly creates the data object without accessing for the aggregate of allocation method partial information 22 possessed by the server apparatus 30 or each of the storage nodes.

As an example of the allocation method, the meta server method with a range can be conceived. It is supposed that the server apparatus 30 is the meta server, and a part of information stored in the meta server corresponds to the aggregate of allocation method partial information 22 stored in each of the storage nodes. It is supposed that each information stored in the meta server is a pair of an identifier of each data object and an identifier of the storage node in which the each data object is stored. Further, in the meta server method with a range, for each range consisting of identifiers of data objects or hush values each associated with a corresponding one of the identifiers of data objects, the storage node to be allocated, when a data object corresponding to the each range is newly created in response to CREAT, is further determined. Information related to the range is also retained on the client terminal 10 asynchronously.

Here, the “asynchronous” means an update information transmission method in which, even when updating is performed on an aggregate of original data objects (here, which corresponds to the aggregate of allocation method partial information 22 possessed by each storage node) and a certain operating subject, from which updated data objects can be acquired, exists on a system, there is a possibility that the client terminal 10 refers to non-updated data existing on the asynchronous cache 12 which is retained by the client terminal 10 itself.

As an example of the asynchronous method, there can be conceived a method in which update information is retained in the server apparatus 30 without being transmitted until a predetermined time point, or the update information is retained in the server apparatus 30 without being transmitted until an update amount thereof comes to a predetermined amount, and when the time has come to the predetermined time point or when the update amount has come to the predetermined amount, the update information is transmitted to the asynchronous cache 12 of the client terminal 10.

As another example of the asynchronous method, the following example can be conceived. That is, there can be conceived a method in which the server apparatus 30 retains the update information without actively transmitting the update information to the asynchronous cache 12 of the client terminal 10, and when received a request for updating of information from the client terminal 10, the server apparatus 30 transmits the pieces of update information to the asynchronous cache 12 of the client terminal 10 in response to the request. In this regard, however, a method of realizing the asynchronous cache 12 in this exemplary embodiment is not limited to these.

In the distributed storage system, data migrations are performed. The data migration means a process of moving one or more data objects stored in the storage node to another storage node. Here, the data migration may be copying of data objects. In moving data objects, the data objects on the original storage node are deleted. In contrast, in the case of copying of data objects, the data objects on the original storage node are not deleted, and thus, the number of copies of the data objects increases.

The move of data objects occurs due to a cause, such as a failure recovery or increasing/decreasing of the number of storage nodes in conjunction with load balancing, a performance improvement, a system reinforcement or system downsizing. In this regard, however, in this exemplary embodiment, the cause of occurrence of the data migration is not limited to these.

In the data migration, when data objects have been transferred among the storage nodes 20a to 20c, the client terminal 10 becomes incapable of searching for a target data object. Thus, it is necessary to update the allocation information in conjunction with the data migration.

FIG. 3 is a block diagram illustrating an example of a configuration of a storage system according to this exemplary embodiment. Referring to FIG. 3, this storage system includes a client terminal 10, the storage node 20 and a server apparatus 30. Further, the client terminal 10 includes an access unit 11 and an asynchronous cache 12. Moreover, the storage node 20 includes a determination unit 21, an aggregate of allocation method partial information 22, an update unit 23 and a data storage unit 24.

The asynchronous cache 12 retains correspondence relationships between identifiers of the object data and identifiers of the storage nodes each are to handle the access requests for the object data. The access unit 11 determines the storage node expected to deal with the access request on the basis of the correspondence relationships stored in the asynchronous cache 12, and transmits the access request to the determined storage node.

Upon receiving the access request from the client terminal 10, the determination unit 21 determines whether or not the access request is to be handled by itself, and notifies the client terminal 10 of the determined result. The update unit 23 updates the storage nodes that are to handle the access requests. The server apparatus 30 accumulates a piece of update information representing the content of updating having been performed by the storage node 20. When having updated the storage node that is to handle the access request, the update unit 23 of the storage node 20 notifies the server apparatus 30 of a piece of update information indicating the content of the updating.

The asynchronous cache 12 changes the aforementioned correspondence relationships in accordance with the update information having been accumulated in the server apparatus 30, asynchronously with the update the storage node that is to handle the access request by the storage node 20.

Next, operation of the storage system according to this exemplary embodiment will be described with reference to some of the drawings.

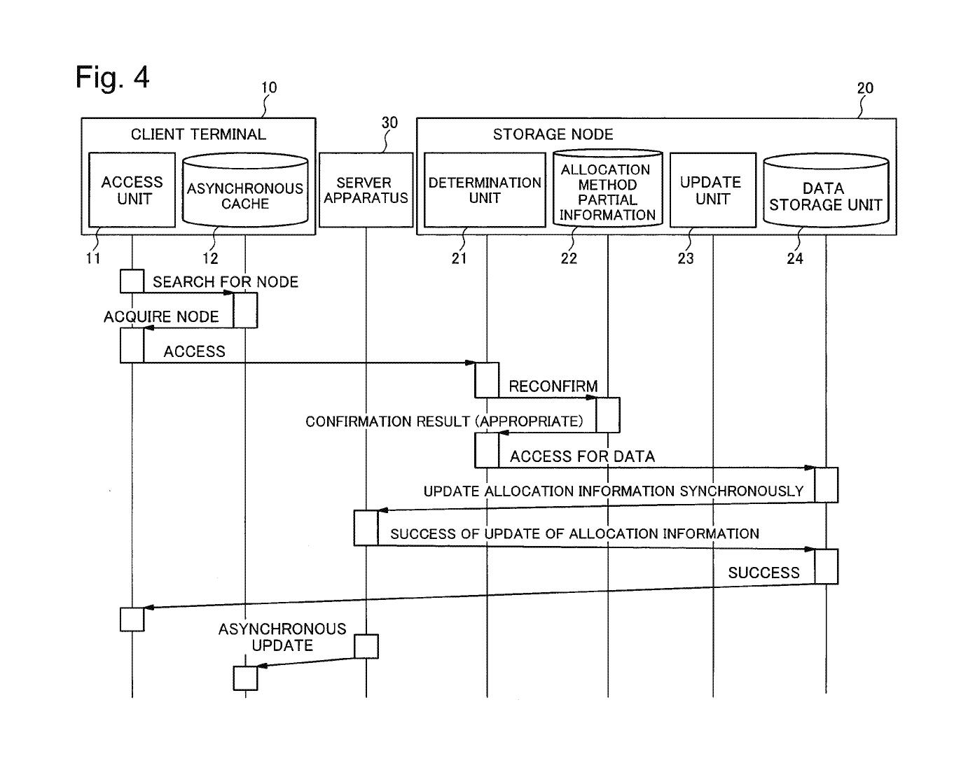

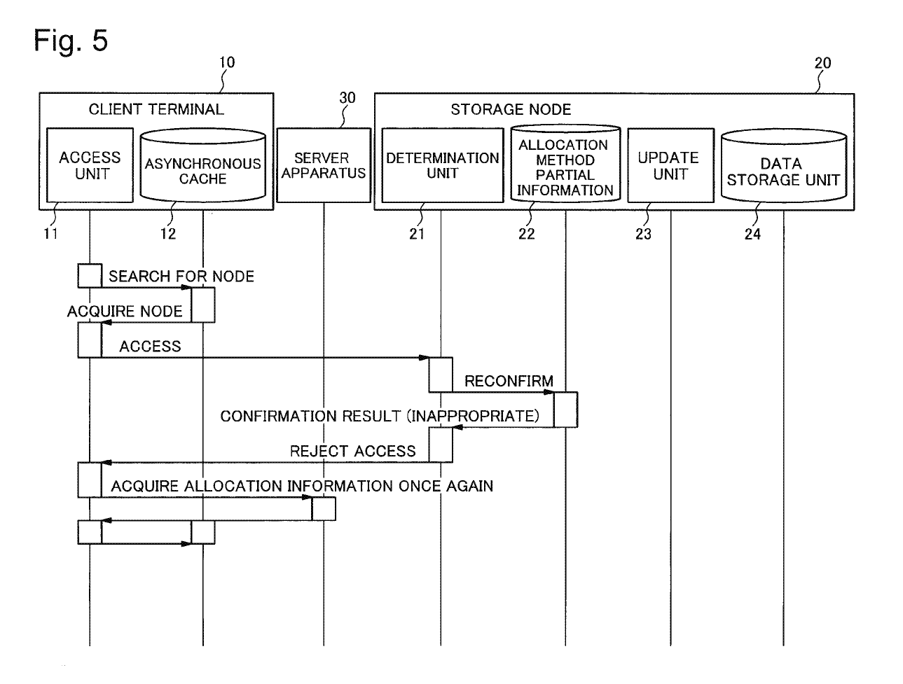

In the distributed storage system of this exemplary embodiment, CREATE or INSERT of a data object is handled as described below. Here, a case where a data object A is newly created in the system will be described with reference to FIGS. 4 and 5.

FIG. 4 is a sequence diagram illustrating operation in a case where an access destination is stored in the storage node having been determined by the asynchronous cache 12.

Referring to FIG. 4, the access unit 11 of the client terminal 10 determines a data access destination storage node by using pieces of information stored in the asynchronous cache 12. It is supposed here that the storage node 20 has been determined as the access destination.

Next, the client terminal 10 transmits the access request, which means “CREATE”, to the storage node 20. Here, firstly, this access request is utilized by the determination unit 21. The determination unit 21 confirms whether or not this request is allowed to be handled by the storage node 20 by using the aggregate of allocation method partial information 22. In the case where, as a result of the confirmation process, it is appropriate from an aspect of data allocation that the CREATE is handled by the storage node 20, the data object is created on the storage node 20. Moreover, the aggregate of allocation method partial information 22 and the server apparatus 30 are updated, and thereby it is recorded that the relevant data object is stored in the storage node 20.

Subsequently, the storage node 20 sends back information indicating the success of the access to the client terminal 10. In addition, the information indicating the success of the access may be sent back, not at the last stage of the sequence, but at a stage anterior thereto.

The server apparatus 30 applies a piece of updated information to the asynchronous cache 12 existing on the client terminal 10 asynchronously.

FIG. 5 is a sequence diagram illustrating operation of a case where the storage node having been determined as an access destination by the asynchronous cache 12 is false from an aspect of the allocation method.

Referring to FIG. 5, the access unit 11 of the client terminal 10 determines a data access destination storage node by using the information stored in the asynchronous cache 12. It is supposed here that the storage node 20 has been determined as the access destination.

Next, the client terminal 10 transfers the access request, which means CREATE, to the storage node 20. Firstly, the access request is utilized by the determination unit 21. The determination unit 21 confirms whether or not this request is allowed to be handled by storage node 20 by using the aggregate of allocation method partial information 22. In the case where, as a result of the confirmation process, it is inappropriate from an aspect of data allocation that the CREATE is handled by the storage node 20, the determination unit 21 sends back a piece of information representing that the access is false to the client terminal 20.

Next, the client terminal 10 updates information which has been possessed by its own asynchronous cache 12 into correct information possessed by the server apparatus 30. In order to update the information stored in the asynchronous cache 12, for example, as shown in FIG. 5, the client terminal 20 may acquire information from the server apparatus 30. Further, the client terminal 10 may wait during a predetermined period of time until a new update has been transmitted from the server apparatus 30. In this regard, however, a procedure of reflecting new information into the asynchronous cache 12 from the server apparatus 30 once again is not limited to these methods.

The client terminal 10 issues CREATE to the storage node conforming to new allocation method information once again. Subsequent operations are the same as those illustrated in the sequence diagram of FIG. 4.

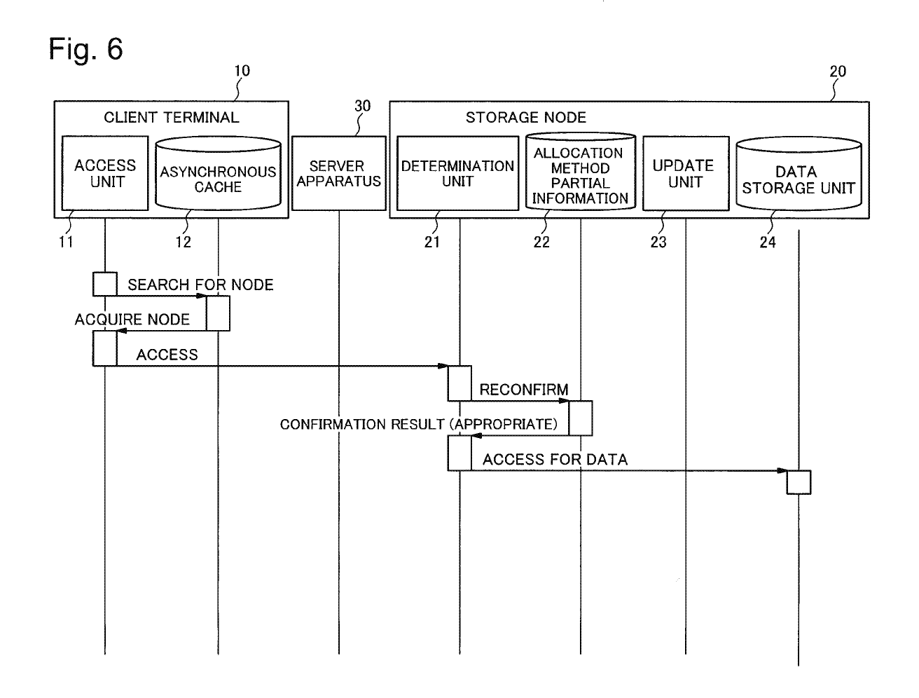

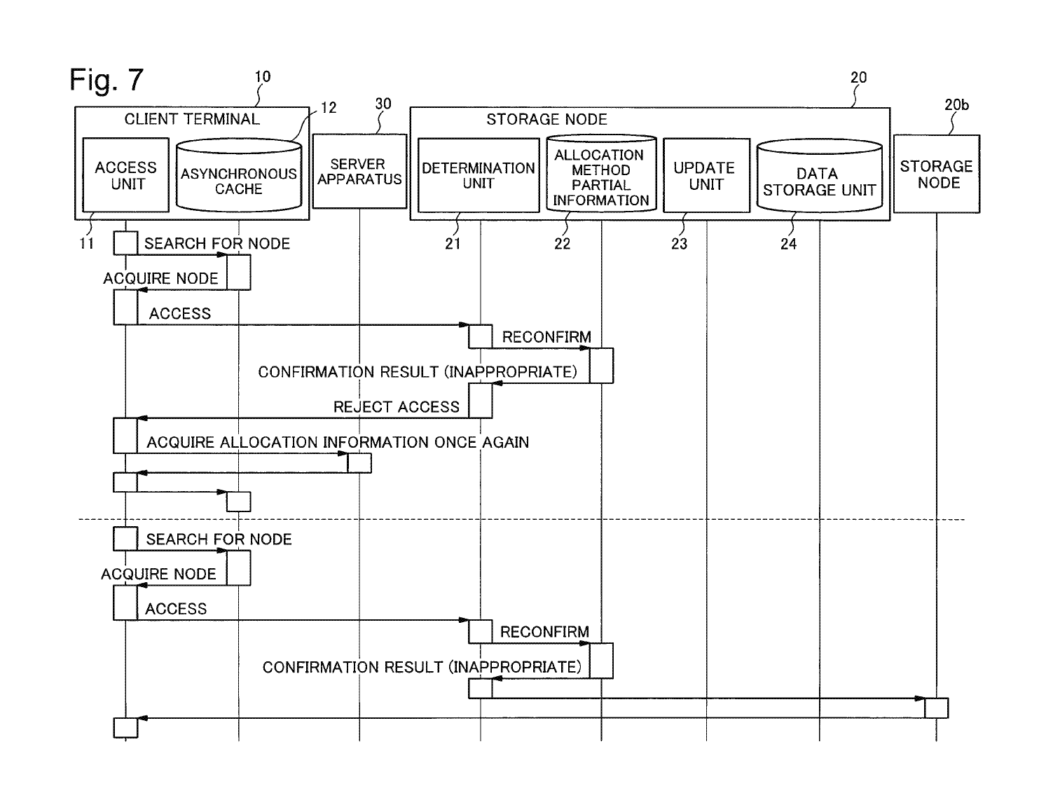

Meanwhile, in the distributed storage system of this exemplary embodiment, READ and UPDATE regarding already stored data are each performed as described below. Here, with respect to a data object A already existing in a system, a case where READ is issued and a case where UPDATE is issued will be described with reference to FIG. 6 and FIG. 7, respectively.

In the case of READ, the client terminal 10 issues a request accompanied by an identifier of a target data object and further, when needed, information representing a portion to be read out in a target data object (i.e., at least one of a property name, a byte-range/a piece of offset information, and the like), and receives data which complies with the request, or error information. Meanwhile, in the case of UPDATE, the client terminal 10 transmits an identifier of a target data object and further, when needed, information representing a portion targeted for overwriting in a target data object (i.e., at least one of a property name, a byte-range/a piece of offset information, and the like), as well as a block of data itself corresponding to the overwriting, in a simultaneous manner, a sequential manner or an interactive manner, and receives information representing the approval/disapproval of the access.

FIG. 6 is a sequence diagram illustrating operation of a case where the data object A, which is an access destination, is stored in the storage node having been determined by the asynchronous cache 12.

Referring to FIG. 6, the access unit 11 of the client terminal 10 determines a data access destination storage node by using the information stored in the asynchronous cache 12. It is supposed here that the storage node 20 has been determined as the access destination.

Next, the client terminal 10 transfers the access request representing READ or WRITE described above to the storage node 20. Here, firstly, this access request is utilized by the determination unit 21. The determination unit 21 confirms whether or not this request is allowed to be handled by the storage node 20 by using the aggregate of allocation method partial information 22. In the case where, as a result of the confirmation process, it is appropriate from an aspect of data allocation that this CREATE is handled by the storage node 20, a data object is accessed for on the storage node 20.

Subsequently, the storage node 20 sends back information indicating the success of the access to the client terminal 10. In addition, the information indicating the success of the access may be sent back, not at the last stage of the sequence, but at a stage anterior thereto.

FIG. 7 is a sequence diagram illustrating operation of a case where the storage node having been determined as an access destination by the asynchronous cache 12 is false from an aspect of an allocation method. That is, in this case, the storage node 20 is in either a state where the storage node 20 itself does not contain a target data object, or a state where, although the storage node 20 itself contains the target data object, the storage node 20 is incapable of dealing with the access request.

As an example of the state where the storage node 20 is incapable of dealing with the access request although it contains a target data object, there can be conceived a case where a reservation for a migration is made on the target data object. As another example thereof, there can be conceived a case where an access authorization, such as READ enabled/disabled or UPDATE enabled/disabled, is set for each of copies of a plurality of data objects, and an access for the copy does not comply with the access authorization. Moreover, as another example thereof, there can be conceived a case where accesses are concentrated on the target data object and the storage node 20 is in the state of being incapable of dealing with the relevant access request from an aspect of load balancing. In addition, in this exemplary embodiment, a case where the determination unit rejects the access request is not limited to these.

An upper portion (a portion above a dashed line) in FIG. 7 illustrates an example in which a rejection response is sent back to the client terminal 10 after a reconfirmation.

Referring to the upper portion in FIG. 7, the access unit 11 of the client terminal 10 determines a data access destination storage node by using the information stored in the asynchronous cache 12. It is supposed here that the storage node 20 has been determined as the access destination.

Next, the client terminal 10 transfers the access request representing READ or WRITE to the storage node 20. Here, firstly, the access request is utilized by the determination unit 21. The determination unit 21 confirms whether or not this request is allowed to be handled by the storage node 20 by using the aggregate of allocation method partial information 22. In the case where, as a result of the confirmation process, it is inappropriate from an aspect of data allocation that the request is handled by the storage node 20, the determination unit 21 sends back information representing that the access is false to the client terminal 20.

Afterwards, the client terminal 10 updates information which has been retained in its own asynchronous cache 12 into the correct information possessed by the server apparatus 30. In order to update the information stored in the asynchronous cache 12, for example, as shown in FIG. 5, the client terminal 20 may acquire information from the server apparatus 30. Further, the client terminal 10 may wait during a predetermined period of time until a new update has been transmitted from the server apparatus 30. In this regard, however, a procedure of reflecting pieces of new information into the asynchronous cache 12 from the server apparatus 30 once again is not limited to these methods.

The client terminal 10 issues CREATE to the storage node conforming to new allocation method information once again. Subsequent operations are the same as those illustrated in the sequence diagram of FIG. 6.

A lower portion (a portion below the dashed line) in FIG. 7 illustrates an example in which access is transferred to a different storage node 20b capable of dealing with the access after the reconfirmation.

Referring to the lower portion of FIG. 7, the access unit 11 of the client terminal 10 determines a data access destination storage node by using information stored in the asynchronous cache 12. It is supposed here that the storage node 20 has been determined as the access destination.

Next, the client terminal 10 transfers the access request representing READ or WRITE to the storage node 20. Here, firstly, the access request is utilized by the determination unit 21. The determination unit 21 confirms whether or not this request is allowed to be handled by the storage node 20 by using the aggregate of allocation method partial information 22. In the case where, as a result of the confirmation process, it is inappropriate from an aspect of data allocation that the request is handled by the storage node 20, the storage node 20 transfers the access to the different storage node 20b, and requests the storage node 20b to handle the access.

As a method of selecting the storage node 20b, the following method can be conceived. That is, there can be conceived a method in which past migration information related to the data object A is recorded in the storage node 20 during a predetermined period, and the storage node 20b, which is a migration destination, is selected in accordance with the past migration information. As another method, there can be conceived a method in which any one of storage nodes other than itself is selected, and the access is transferred to the selected storage node to request the transfer destination storage node to determine whether or not the access can be handled thereby. Moreover, as another method, the following method can be conceived. That is, a certain number of storage nodes are selected, and an inquiry for confirming whether or not the relevant data object A is retained is transmitted to each of the selected storage nodes from the storage node 20. Subsequently, in accordance with a result of responses to the inquiry, the storage node retaining the data object A is extracted. In this regard, however, a method for selecting the second storage node 20b is not limited to these.

The storage node 20b, to which the access request has been transferred, deals with the access request, and transmits a response to the client terminal 10. The storage node 20b may directly transmit the response to the client terminal 10. Further, as another method, the storage node 20b may transmit the response to the terminal 10 via the storage node 20 which has firstly received the access from the client terminal 10.

In the sequence diagram shown in each of FIGS. 4 to 7, each of the units, that is, the client terminal 10 and storage node 20, is the operating subject. In this regard, however, configuration may be made such that a controller for performing intensive control of each of the client terminal 10 and the storage node 20 is provided, and this controller interactively issues commands to each of these unit.

According to the distributed storage system of this exemplary embodiment, it is possible to provide a distributed storage system having a flexible data allocation method and high access performance. Through a method of providing the server apparatus 30, an allocation method of the distributed storage system of this exemplary embodiment can be made a method similar to the aforementioned meta server method. Thus, according to this exemplary embodiment, as compared with a case where only the dispersion function method is employed, a larger number of storage nodes can be made migration destinations of pieces of object data, so that flexible data allocation can be achieved.

Further, according to this exemplary embodiment, high access performance is realized by the asynchronous cache 12 possessed by the client terminal 10, the determination unit 21 possessed by the storage node 20, and the update unit 23 utilized by the determination unit 21.

The client terminal 10 is also capable of accessing the storage node with respect to any one of requests regarding READ and UPDATE without through such a centralized component that controls the entire system. Thus, through a method of dispersing an access load to a large number of computer resources, the occurrence of a situation in which a particular component becomes a bottleneck can be prevented, and this brings about high access performance.

Further, with respect to CREATE, updating on pieces of allocation information is also stored in the aggregate of allocation method partial information 22 possessed by each storage node. Thus, it is possible to access any one of storage nodes without using a method, such as the conventional meta server method, in which access to the storage node is made through such a centralized component that controls the entire system.

Moreover, the fault of an access destination due to the asynchronous property of the asynchronous cache 12 is corrected by the determination unit 21. Thus, neither mismatching between data objects nor creation of data object inaccessible from a client terminal occurs.

As described above, it is possible to provide a distributed storage system which makes it possible to achieve flexible data allocation simultaneously with maintaining a matching property in data allocation, and achieve high-speed processing by preventing the meta server from becoming a bottleneck.

### Exemplary Embodiment 2

A storage system according to this second exemplary embodiment will be described with reference to some of the drawings.

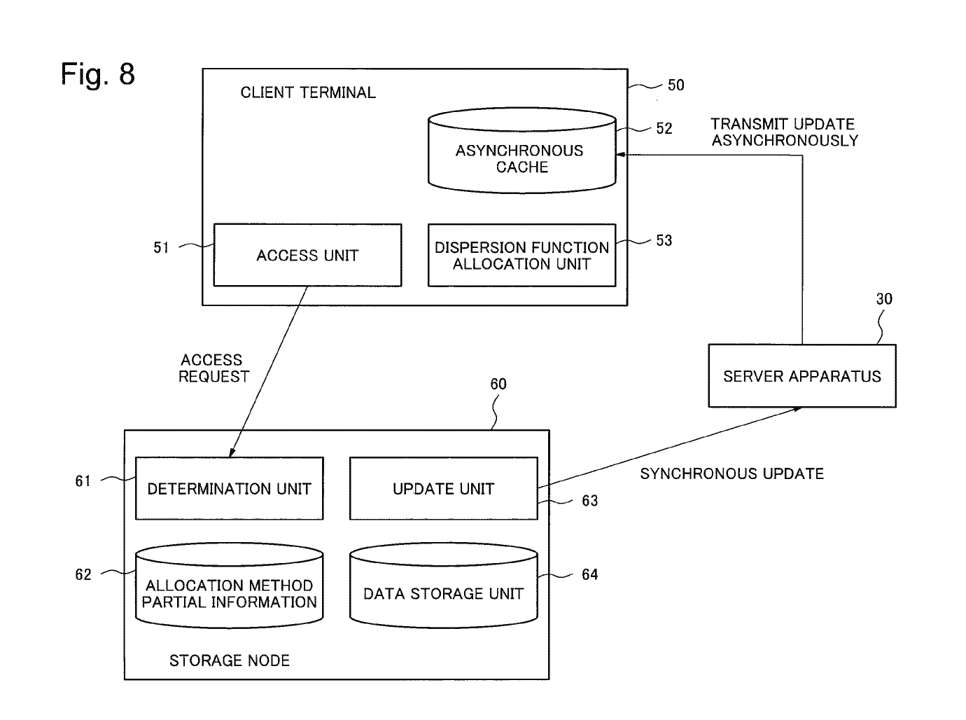

FIG. 8 is a block diagram illustrating an example of a configuration of a storage system according to this exemplary embodiment. Referring to FIG. 8, this storage system includes a client terminal 50, a storage node 60 and a server apparatus 30. Further, the client terminal 60 includes an access unit 51, an asynchronous cache 52 and a dispersion function allocation unit 53. Moreover, the storage node 60 includes a determination unit 61, an aggregate of allocation method partial information 62, an update unit 63 and a data storage unit 64. Although, in FIG. 8, there is illustrated only one storage node 60 for the sake of simplification, it is supposed that this storage system includes a plurality of storage nodes.

The asynchronous cache 52 retains correspondence relationships between identifiers of the object data and identifiers of the storage nodes that are to handle the access requests for the object data. In this exemplary embodiment, the correspondence relationships retained by the asynchronous cache 52 are ones regarding only pieces of object data, among the above pieces of object data, each of which has already been moved (migrated) between the storage nodes.

The dispersion function allocation unit 53 determines the storage node that is to handle the access request for a target object on the basis of a given dispersion function (for example, a hash function).

The access unit 51 determines the storage node that is to handle the access request on the basis of the aforementioned correspondence relationships stored in the asynchronous cache 52, and transmits the access request to the determined storage node. Meanwhile, when the access unit 51 fails to determine any storage node that is to handle the access request on the basis of the aforementioned correspondence relationships stored in the asynchronous cache 52, the access unit 51 determines the storage node that is to handle the access request on the basis of the given dispersion function by using the dispersion function allocation unit 53. Further, the access unit 51 transmits the access request to the determined storage node.

The aggregate of allocation method partial information 62 retains pieces of information each representing the storage node that is to handle the object data, among the object data, which have already been moved between the storage nodes (hereinafter, the above pieces of information retained by the aggregate of allocation method partial information 62 being referred to as pieces of “storage information of data which already been moved”) Upon receiving the access request from the client terminal 50, the determination unit 61 determines whether or not the access request is to be handled by itself by referring to the aggregate of allocation method partial information 62, and notifies the client terminal 50 of the determined result. The update unit 63 updates the storage nodes that are to handle the access requests. The server apparatus 30 accumulates a piece of update information representing the content of updating having been performed by the storage node 60. When having updated the storage node that is to handle the access request, the update unit 63 of the storage node 60 notifies the server apparatus 30 of a piece of update information indicating the content of the updating.

The asynchronous cache 52 changes the aforementioned correspondence relationships in accordance with the update information having been accumulated in the server apparatus 30, the change being made asynchronous with the update the storage node that is to handle the access request by the storage node 60.

The storage system of this exemplary embodiment and the storage system of the first exemplary embodiment are mutually different in a method for realizing the allocation method. In this exemplary embodiment, as shown in FIG. 8, the allocation method is realized by the dispersion function allocation unit 53 and the asynchronous cache 52.

In this method, access from the client terminal 50 regarding each of CREATE and INSERT is handled by the dispersion function allocation unit 53 on the basis of the dispersion function method. With respect to each of only data objects having been migrated, entries which are identified by pairs of an identifier of the data objects and the storage node storing the data objects is retained by means of the meta server method. In this regard, however, configuration is made such that each entry can be also referred to in the storage node storing the relevant data object.

Part of or the whole of data objects having already been moved are cached on the client terminal 50 asynchronously. Here, the definition of the “asynchronous” method is the same as the definition in the first exemplary embodiment.

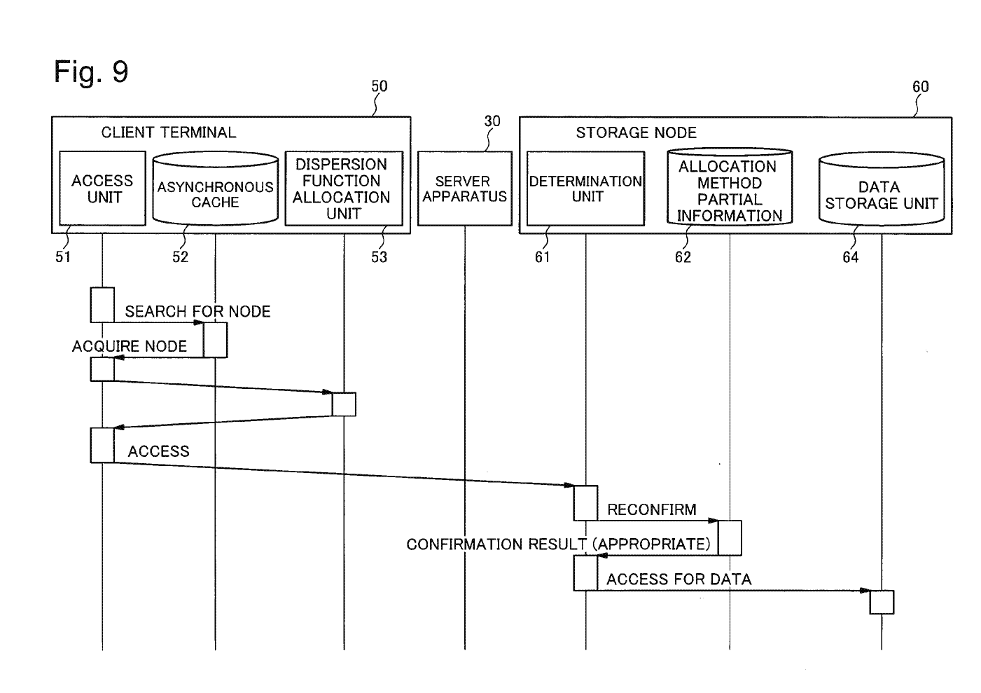

Each of READ and UPDATE from the client terminal 50 are carried out in accordance with a procedure described below. FIG. 9 is a sequence diagram illustrating an example of operation of each of READ and UPDATE in the storage system of this exemplary embodiment. The client terminal 50 firstly looks for the storage node on the basis of the asynchronous cache 52. When having not been able to find any piece of information related to a target data object, the client terminal 50 looks for the storage node by using the dispersion function method.

Next, the client terminal 50 accesses the determined storage node (which is denoted by the storage node 60).

The determination unit 61 of the storage node 60 confirms whether the storage node 60 is to handle the access or not, on the basis an aggregate of information including at least the pieces of storage information of data which have already been moved.

In the case where the access is allowed to be handled, the storage node 60 deals with the access. In contrast, in the case where the access is not allowed to be handled, the storage node 60 transmits a response indicating this confirmation result to the client terminal 50 or requests a different storage node to handle the access. In addition, operations in the case where the access is not allowed to be handled may be made the same as those in the first exemplary embodiment.

According to the distributed storage system of this exemplary embodiment, it is possible to provide a distributed storage system having the flexible data allocation method and high access performance.

With respect to data objects having already been moved, it is possible to make the allocation method therefor a method similar to the meta server method. Thus, according to this exemplary embodiment, as compared with a case where only the dispersion function method is employed, a larger number of storage nodes can be made migration destinations of pieces of object data, so that flexible data allocation can be achieved.

Further, according to this exemplary embodiment, high access performance is achieved by the asynchronous cache 52 possessed by the client terminal 50, the determination unit 61 possessed by the storage node 60, and the update unit 63 utilized by the determination unit 61.

With respect to CREATE as well as READ and UPDATE regarding a large number of data objects each having not become a candidate for a data migration, through the allocation method in accordance with the dispersion function method, access to the storage node can be made without, on its way, passing through such a centralized component that controls the entire system. Thus, an access load is dispersed to a large number of computer resources and this brings about high access performance.

Further, with respect to data objects each having become a candidate for a data migration, their respective updates of allocation information are retained in the aggregate of allocation method partial information 22 possessed by each of the storage nodes. Thus, it is possible to access any one of storage nodes without using a method, such as the conventional meta server method, in which access to the storage node is made through such a centralized component that controls the entire system.

Moreover, the fault of the access destination due to the asynchronous property of the asynchronous cache is corrected by the determination unit. Thus, neither mismatching between data objects nor creation of data object inaccessible from a client terminal occurs.

As described above, it is possible to provide the distributed storage system which makes it possible to achieve flexible data allocation simultaneously with maintaining a matching property in data allocation, and achieve high-speed processing by preventing the meta server from becoming a bottleneck.

It is possible to apply the data storage system according to some aspects of the present invention to, for example, a parallel database, a parallel data processing system, a distributed storage, a parallel file system, a distributed database, a cluster computer and a distributed key-value store.

It is to be noted here that the individual disclosures in the aforementioned prior art literatures, such as the patent literature, are incorporated in this description by way of citation. Any change and/or coordination on the exemplary embodiments can be made within the scope of the entire disclosure of the present invention (including appended claims), and further on the basis of the fundamental technical thought of the present invention. A variety of combinations and/or selections with respect to various disclosure constitutes (including the individual constitutes of individual appended claims, the individual constituents of the individual exemplary embodiments and the individual constitutes of the individual drawings) can be made within the scope of appended claims of the present invention. That is, naturally, the present invention involves various modifications and amendments those of the skilled in the art could make in accordance with the entire disclosure including appended claims and the technical thought regarding the present invention. In particular, with respect to numerical value ranges described in this description, even though any numerical value or small range falling within each of the range is not otherwise described, it is to be interpreted that the relevant numerical value ranges are concretely described.

### REFERENCE SIGNS LIST

10 and 50: client terminal

11 and 51: access unit

12 and 52: asynchronous cache

20, 20a to 20c and 60: storage node

21 and 61: determination unit

22, 22a to 22c and 62: allocation method partial information

23 and 63: update unit

24, 24a to 24c and 64: data storage unit

25a to 25c: data transmission/reception unit

26a to 26c: CPU

30: server apparatus

53: dispersion function allocation unit

40: network

What is claimed is:

1. A storage system comprising:
a client terminal; and
a plurality of storage nodes,
wherein the client terminal includes an asynchronous cache that retains an correspondence relationship between an identifier of object data and an identifier of the storage node that is to handle an access request for the object data, and an access unit that determines the storage node that is to handle the access request on the basis of the correspondence relationship stored in the asynchronous cache, and that transmits the access request to the determined storage node,
wherein the storage node includes a determination unit that determines, upon receiving the access request from the client terminal, whether the access request is to be handled by itself, and notifies the client terminal of the determined result, and an update unit that updates the storage node that is to handle the access request, and
wherein the asynchronous cache changes the correspondence relationship in accordance with the update, the change being made asynchronous with the update by the storage nodes.

2. The storage system according to claim 1, further comprising a server apparatus that accumulates a piece of update information representing content of the update by the storage node,
wherein, when the update unit of the storage node updates the storage node that is to handle the access request, the update unit notifies the server apparatus of the update information representing content of the update, and
wherein the asynchronous cache changes the correspondence relationship in accordance with the update information accumulated in the server apparatus, the change being made asynchronous with the update by each of the storage nodes.

3. The storage system according to claim 2, wherein the server apparatus periodically notifies the update information to the client terminal, and the asynchronous cache changes the correspondence relationship in accordance with the update information which is notified by the server apparatus.

4. The storage system according to claim 2, wherein the server apparatus notifies the update information to the client terminal when a data amount of the update information becomes larger than or equal to a predetermined size, and the asynchronous cache changes the correspondence relationship in accordance with the update information which is notified by the server apparatus.

5. The storage system according to claim 2, wherein the access unit requests the sever apparatus to notify the update information to the client terminal when the determination unit determines the storage node is not to handle the access request, the storage node being determined on the basis of the correspondence relationship by the access unit, and the asynchronous cache changes the correspondence relationship in accordance with the update information which is notified by the server apparatus in response to the request.

6. The storage system according to claim 1, wherein the determination unit transfers the access request to one of the storage nodes that is to handle the access request when the access request is not to be handled by the storage node itself which includes the determination unit.

7. The storage system according to claim 1, wherein the asynchronous cache retains an correspondence relationship between an identifier of the object data which already being moved between the storage nodes and an identifier of the storage node that is to handle the access request for the object data, and
wherein, when the access unit fails to determine any one of the storage nodes that is to handle the access request on the basis of the correspondence relationship retained by the asynchronous cache, the access unit determines one of the storage nodes that is to handle the access request on the basis of a predetermined dispersion function, and transmits the access request to the determined storage node.

8. A data access method comprising:
retaining, by a client terminal, an correspondence relationship between an identifier of object data and an identifier of the storage node that is to handle an access request for the object data into an asynchronous cache;
determining, by the client terminal, the storage node that is to handle the access request on the basis of the correspondence relationship stored in the asynchronous cache, and transmitting, by the client terminal, the access request to the determined storage node;
determining, by the storage node which receives the access request from the client terminal, whether or not the access request is to be handled by itself, and notifying, by the storage node, the client terminal of the determined result;
updating, by the storage node, the storage node that is to handle the access request; and
changing, by the client terminal, the correspondence relationship stored in the asynchronous cache in accordance with the update, the change being made asynchronous with the update by the storage node.

9. The data access method according to claim 8, further comprising:
accumulating, by a server apparatus, a piece of update information representing content of the update by the storage node;
when updating, by the storage node, the storage node that is to handle the access request, notifying, by the storage node, the server apparatus of the update information representing content of the update; and
changing, by the client terminal, the correspondence relationship stored in the asynchronous cache in accordance with the update information accumulated in the server apparatus, the change being made asynchronous with the update by the storage nodes.

10. The data access method according to claim 9, further comprising: notifying, by the server apparatus, the update information to the client terminal periodically; and
changing, by the client terminal, the correspondence relationship stored in the asynchronous cache in accordance with the update information which is notified by the server apparatus.

11. The data access method according to claim 9, further comprising:
notifying, by the server apparatus, the update information to the client terminal when a data amount of the update information becomes larger than or equal to a predetermined size; and
changing, by the client terminal, the correspondence relationship stored in the asynchronous cache in accordance with the update information which is notified by the server apparatus.

12. The data access method according to claim 9, further comprising:
requesting, by the client terminal, the sever apparatus to notify the update information to the client terminal when the storage node, which received the access request, determines the storage node is not to handle the access request, the storage node being determined on the basis of the correspondence relationship by the client terminal; and
changing, by the client terminal, the correspondence relationship stored in the asynchronous cache in accordance with the update information which is notified by the server apparatus in response to the request.

13. The data access method according to claim 8, further comprising:
when the access request is not to be handled by the storage node itself which received the access request, transferring, by the storage node, the access request to the storage node that is to handle the access request.

14. The data access method according to claim 8, wherein the asynchronous cache retains an correspondence relationship between an identifier of the object data which already being moved between storage nodes and an identifier of the storage node that is to handle the access request for the object data, and
wherein, when any one of the storage nodes that is to handle the access request fails to be determined by the client terminal on the basis of the correspondence relationship retained by the asynchronous cache, one of the storage nodes that is to handle the access request is determined by the client terminal on the basis of a predetermined dispersion function, and the access request is transmitted to the determined storage node by the client terminal.
